(19) United States
(12) Patent Application Publication
(10) Pub. No.: US 2002/0121272 A1
(43) Pub. Date: Sep. 5, 2002

(54) Ignition system with an ignition coil

(76) Inventor: Markus Kraus, Jenbach (AT)

Correspondence Address: Anthony M. Lrousso, Lorusso & Loud, 440 Commercial Street, Boston, MA, 02109, US

(21) Appl. No.: 09/976,812

(22) Filed: Oct. 12, 2001

(30) Foreign Application Priority Data
Oct. 16, 2000 (AT) A 1763/2000

(51) Int. Cl. F02P 1/00

(52) U.S. Cl. 123/644; 123/606

(57) ABSTRACT

Ignition system with an ignition coil that is supplied on the primary side by a high frequency source (HF source), wherein the voltage output by the HF source is pulse width modulated and a means (6) for picking up the secondary side current (actual value) is provided, wherein a regulating means (8) is provided that regulates the pulse width dependent upon the measured actual value of the current on the secondary side of the ignition coil and upon a pre-selected reference value development of the current amplitude during an ignition spark.

The present invention relates to an ignition system with an ignition coil that is supplied at the primary by a high frequency source (HF source), wherein the voltage provided by the HF source is pulse width modulated and a means for picking up the secondary side current (actual value) is provided.

In EP 0 547 258 A1 the peak value of the current flowing in the spark plug or secondary electrical circuit at the time of ignition or shortly thereafter is compared with a reference value by regulating the closing time. If, for any reason—transformation ratio or condition of the ignition coil, plug or cable etc—the peak value is greater or less than the pre-determined reference value, the closing time of the primary electric circuit is correspondingly shortened or lengthened.

Modern ignition systems are therefore no longer content with producing an ignition spark, but instead want to configure the development or pattern of the ignition spark for each individual ignition spark in order to obtain optimum combustion. It is already known to use a high frequency source as the primary side supply for an ignition coil and to pulse width modulate the voltage provided by the high freqency.

From documents JP 55060554 A, JP 53090531 A and JP 01008357 A moreover, ignition control means are known wherein the primary side feed signal is controlled dependent upon the secondary side measurement signals, In JP 55060664 A, control takes place on the primary side when the secondary side current is less than a previously defined threshold value. In JP 5309031 A, the secondary side current strength and combustion time is enlisted as a control value. In JP 01008357 A, a pulse width control system is provided to control the primary side switching on the basis of an output signal picked up on the secondary side.

According to the invention, the aim is now to afford an opportunity to configure the development or pattern of the ignition spark in a freely pre-selectable manner.

It is thus provided according to the invention that a regulating means is provided that regulates the pulse width depending on the picked-up actual value of the current on the secondary side of the ignition coil and on a pre-selected reference value development of the current amplitude during an ignition spark. In this way a reference value development of pattern for the ignition current during an ignition spark can be pre-selected. The regulating means picks up the actual value of the current during the ignition spark, and then, by means of the pulse width modulation, influences the current output such as to substantially retain the reference value development in terms of current amplitude.

In addition, or alternatively it can be provided that the voltage regulation is such that the secondary side ignition voltage is limited to a maximum value. With such regulation, it is possible in particular to obtain a voltage limit for the secondary side ignition voltage.

Further advantages and details of the invention will be explained in more detail with reference to the following drawings.

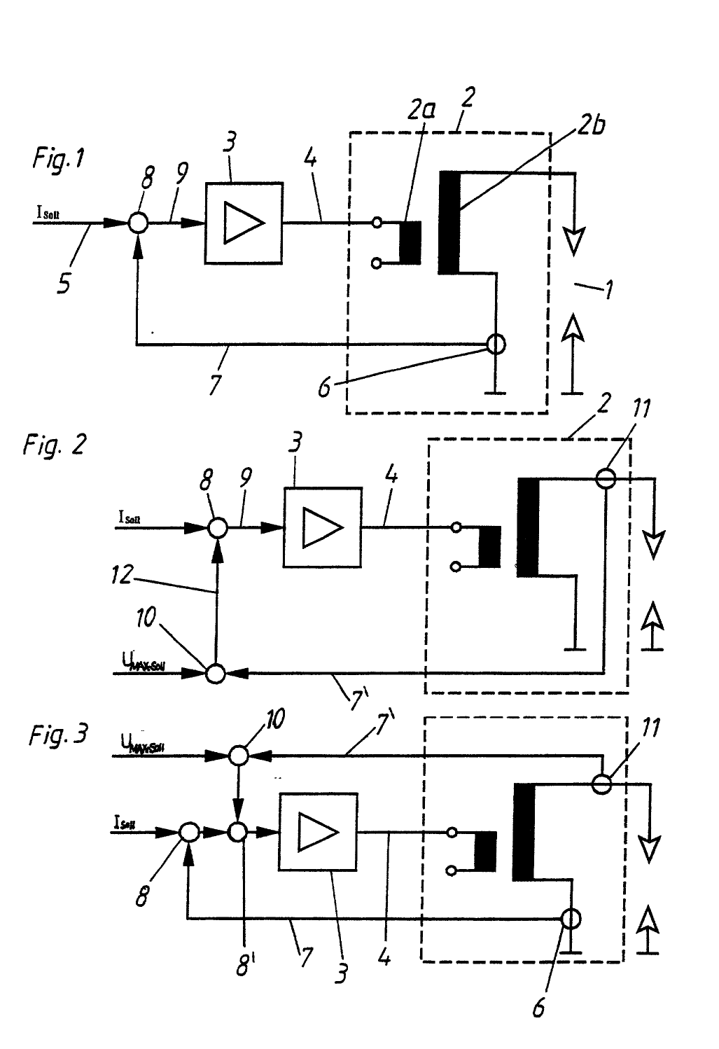

FIGS. 1 to 4 each show different embodiments of an ignition system according to the invention. In the ignition system shown in FIG. 1, the spark plug is labelled 1 and the ignition coil 2. This ignition coil has a secondary circuit 2b and a primary circuit 2a. The primary circuit is supplied by a high frequency source 3 that outputs a pulse width modulated voltage, typically in the range of 50 to 100 kH on the line 4. On the line 5, a reference value current development or pattern can be freely pre-selected, as is shown, for example, in FIG. 5, in the second diagram (Iₛₒₗₗ). The primary side voltage output on the line 4 (shown without spark plug ignition) is pulse width modulated, and shown in FIG. 5 and U_{PRIMAR}. The resulting secondary side high voltage U_{HS} is shown in the fourth diagram of FIG. 5. The secondary side current I_{HS} is evident from the last diagram of FIG. 5.

In accordance with the invention, according to FIG. 1, a means 6 for picking up the secondary side current is provided on the secondary side 2b of the ignition coil 2 (for example, implemented as an instrument shunt). The secondary side actual value of the current is then transferred via the line 7 to the regulating means 8, which outputs a control signal to the HF source via the line 9. This control signal 9 substantially provides the pulse width with which the HF source, when there is a pre-selected, preferably adjustable, frequency on the line 4, then outputs the actual primary voltage to the ignition coil 2.

In the embodiment shown in FIG. 2, instead of the current regulation of FIG. 1, voltage limiting regulation is provided. For this, there is provided a means 11 for picking up the secondary side voltage. In the simplest case, this means 11 is a connecting node for the line 7′. This signal arrives at a regulating means 10 that presets a comparison with a maximum voltage value. When this is exceeded, a signal is given on the line 12 to the regulating means 8 which leads to a reduction in the pulse width and thus to a reduction of the secondary voltage.

As FIG. 3 shows, the current regulation of FIG. 1 can also be combined with the voltage limiting regulation of FIG. 2, wherein for current regulation a first regulator 8 is provided, and for voltage limiting regulation a second regulator 8′.

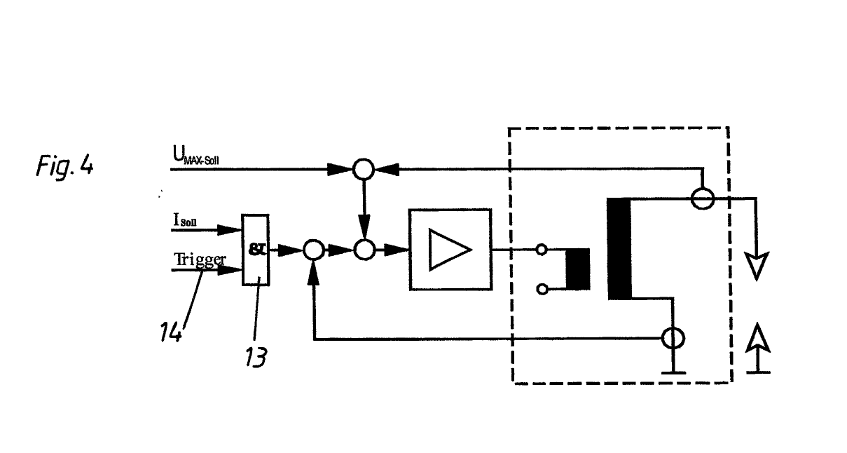

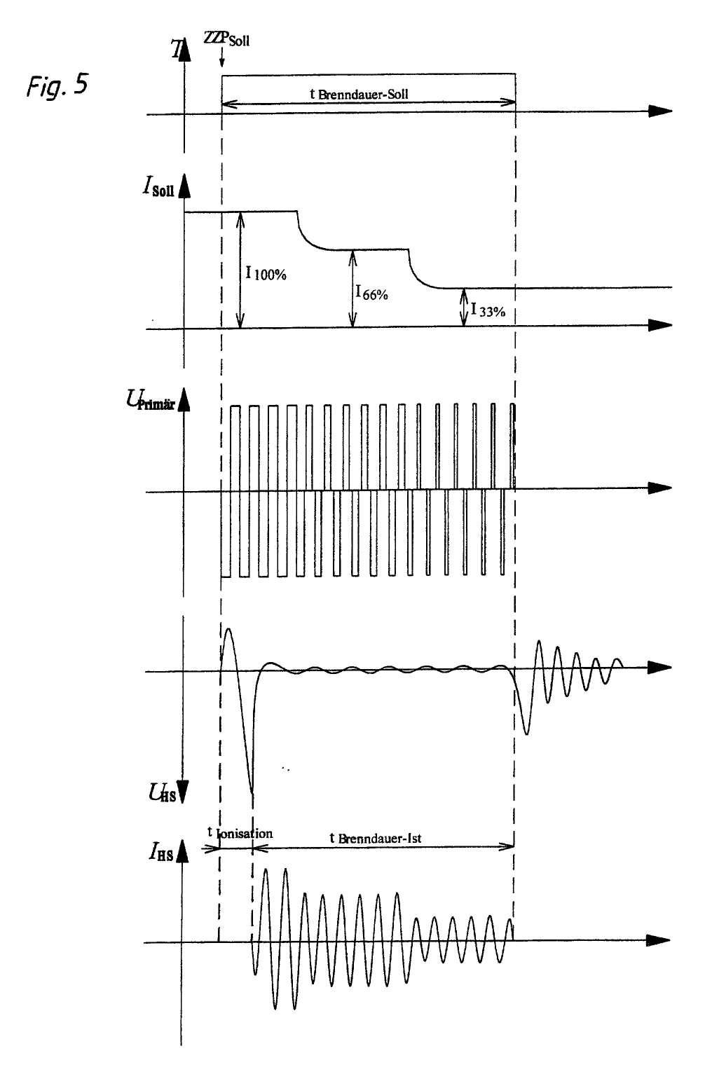

In the embodiment shown in FIG. 4, a trigger input 14 is also provided by way of a round logic gating circuit 13, which trigger determines the beginning and end of an ignition spark. The trigger signal T is shown in FIG. 5 as the uppermose drawing.

1. Ignition system with an ignition coil that is supplied on the primary side by a high frequency source (HF source), wherein the voltage output by the HF source is pulse width modulated and there is provided a means for picking up the secondary side current (actual value), characterised in that a regulating means (8) is provided that regulates the pulse width dependent upon the measured actual value of the current on the secondary side of the ignition coil and upon a pre-selected reference value development of the current amplitude during an ignition spark.

2. Ignition system with an ignition coil that is supplied on the primary side by a high frequency source (HF source), wherein the voltage output by the HF source is pulse width modulated, in particular according to point 1, characterised in that there are provided a means (11) for picking up the secondary side ignition voltage (actual value) and a regulating means (10) that regulates the pulse width dependent upon the measured actual value of the secondary side voltage and upon a pre-selectable reference voltage value.

3. Ignition system according to point 2, characterised in that the voltage regulation is such that it limits the secondary side ignition voltage to a maximum value.

4. Ignition system according to one of points I to 3, characterised in that the frequency of the HF source (3) is matched to the resonance frequency of the ignition circuit.
